(19) United States
(12) Patent Application Publication
(10) Pub. No.: US 2012/0194962 A1
(43) Pub. Date: Aug. 2, 2012

(54) LIGHTNING PROTECTION DEVICE AND WIND TURBINE

(75) Inventors: Meng Yan, Beijing (CN); Jizhuang Lu, Beijing (CN); Qin Zhang, Beijing (CN); Zuohui Liu, Beijing (CN)

(73) Assignee: SINOVEL WIND GROUP CO., LTD., BEIJING (CN)

(21) Appl. No.: 13/355,475

(22) Filed: Jan. 20, 2012

(30) Foreign Application Priority Data
Jan. 31, 2011 (CN) 201110034134.1

(51) Int. Cl. H05F 3/00

(52) U.S. Cl. 361/221

(57) ABSTRACT

The present invention discloses a lightning protection device and a wind turbine. The lightning protection device comprises a machine body fixing frame, a discharging support frame and a guiding elastic piece, wherein the machine body fixing frame is connected and fixed with a machine body; a current collection claw, a guide wheel and a carbon brush are fixedly connected to the discharging support frame, face the side wall of a top conductor at top portion of the lightning protection body and extend out of the discharging support frame; and two ends of the guiding elastic piece are connected with the machine body fixing frame and the discharging support frame respectively, and the relative distance between the machine body fixing frame and the discharging support frame is adjusted. Through the lightning protection device and the wind turbine, effective lightning protection effect can be achieved.

### CROSS-REFERENCE TO RELATED APPLICATIONS

This application claims priority to Chinese Patent Application No. 201110034134.1, filed on Jan. 31, 2011, entitled “Lightning Protection Device and Wind Turbine”, which is incorporated herein by reference in its entirety.

### FIELD OF THE TECHNOLOGY

The present invention relates to a lightning protection and discharging structure technology, in particular to a lightning protection device and a wind turbine.

### BACKGROUND

The lightning phenomenon of the nature has immeasurable damage to high-altitude buildings and equipment, and particularly damage to electronic control systems is more serious. Therefore, a lightning protection device needs to be set for protecting objects which need lightning protection.

Generally, lightning is prevented from directly attacking buildings, structures, electric networks or electric devices in a main mode of arranging lightning rods, lightning belts, lightning nets and lightning wires at the tops of the buildings.

The interstitial point discharge phenomenon is an effective measure of lightning protection, the interstitial point discharge phenomenon achieves the lightning protection effect by controlling the clearance distance between a lightning protection object top conductor and a discharging point, the clearance distance needs to be controlled in a proper range, too large clearance distance affects the lightning protection effect of point discharge, and too short clearance distance causes contact between the discharging point and a lightning protection object so that the lightning protection effect cannot be achieved.

When relative movement exists between the discharging point and the lightning protection body, how to conveniently debug the valid clearance distance between the discharging point and the lightning protection body in order to acquire effective lightning protection effect and protect the discharging point is an important problem and is also a difficult problem.

Particularly in wind power generation, the wind turbine mainly comprises a wind rotor, a generator, an iron tower and a yawing device. The iron tower is a truss for supporting the wind rotor and the generator and is generally built with relatively high height, and the height of certain iron towers reaches more than 100 meters, so the iron tower is particularly important for lightning protection.

Generally, the lightning protection device can be arranged on the nacelle rotating part of the yawing device at the top of the iron tower, so that a certain clearance distance is kept between the discharging point of the lightning protection device and a tower top flange to realize effective lightning protection. When wind power generation equipment executes yawing movement, the nacelle rotates relative to the tower top flange, so relatively fixed clearance distance between the discharging point of the lightning protection device and the tower top flange is difficult to keep, and is the problem and difficulty yet to be solved in the prior art.

### SUMMARY

The present invention provides a lightning protection device and a wind turbine for realizing effective lightning protection and preventing thunder and lightning from damaging wind turbine equipment.

One aspect of the present invention provides a lightning protection device, which comprises a machine body fixing frame, a discharging support frame and a guiding elastic piece, wherein the machine body fixing frame is connected and fixed with a machine body of a lightning protection body; a current collection claw, a guide wheel and a carbon brush are fixedly connected to the discharging support frame, face the side wall of a top conductor at top portion of the lightning protection body and extend out from the discharging support frame, the guide wheel and the carbon brush extend out from the discharging support frame to prop against the side wall of a top conductor at top portion of the lightning protection body, and the length of the current collection claw extending out from the discharging support frame is smaller than the extending length of the guide wheel; and two ends of the guiding elastic piece are connected with the machine body fixing frame and the discharging support frame respectively, and the relative distance between the machine body fixing frame and the discharging support frame is adjusted, so that the guide wheel is propped against the side wall of a top conductor at top portion of the lightning protection body.

The lightning protection device provided by the present invention can ensure the clearance distance between the current collection claw and the side wall of a top conductor at the top portion of the lightning protection body and achieve effective lightning protection effect.

Another aspect of the present invention also provides a wind turbine, which comprises a wind rotor, a generator, an iron tower and a yawing device, and also comprises the lightning protection device provided by the present invention, wherein the machine body fixing frame is fixedly connected with the nacelle rotating part of the yawing device, and the guide wheel and the carbon brush fixed on the discharging support frame are propped against the inner wall of the tower top flange of the iron tower.

The lightning protection device of the present invention is adopted in the wind turbine provided by the present invention, and the discharging clearance distance between the current collection claw and the conductor can be automatically adjusted through the guide wheel, so effective lightning protection is achieved, and safe operation of wind power generation equipment is ensured.

### BRIEF DESCRIPTION OF THE DRAWINGS

FIG. 1 is a structural schematic diagram of a lightning protection device provided by embodiment II of the present invention;

FIG. 2 is a structural schematic diagram of the lightning protection device provided by embodiment II of the present invention in a wind turbine.

Marks of the drawing:

| | | |
|---|---|---|
| 1, machine body fixing | 2, spring; | 3, guide rod; |
| frame; | | |
| 4, discharging support | 5, screw; | 6, guide wheel; |
| frame; | | |
| 7, sliding block; | 8, sliding groove; | 9, current |
| | | collection claw; |
| 10, carbon brush; | 11, guiding elastic | 12, tower top flange; |
| | piece; | |
| 13, nacelle rotating part; | 14, first screw; | 15, second screw; |
| 16, unthreaded hole; | 17, threaded hole. | |

### DETAILED DESCRIPTION

In order that the purposes, the technical schemes and the advantages of the embodiments of the present invention are clearer, the technical schemes in the embodiments are clearly and completely described in combination with the drawings in the embodiments. Obviously, the described embodiments are a part of embodiments of the present invention, not all embodiments. Based on the embodiments in the present invention described here and other teachings in the specification, a person skilled in the art can acquire other embodiments and modify the present invention without creative work, all those modifications and variations are within the range protected by the present invention.

### Embodiment I

The embodiment I of the present invention provides a lightning protection device. The lightning protection device is applied to a lightning protection body, the lightning protection body comprises a machine body and a top conductor, and generally, the top conductor can rotate relative to the machine body. For example, the yawing device of a wind turbine can rotate relative to the iron tower, wherein the iron tower is also named as a tower frame or a tower tube.

The lightning protection device comprises a machine body fixing frame, a discharging support frame and a guiding elastic piece. The machine body fixing frame is fixedly connected with the machine body of the lightning protection body, the lightning protection device is fixed on a certain part of the lightning protection body, and generally, the machine body fixing frame is fixedly connected with the machine body at the top of the lightning protection body.

A current collection claw, a guide wheel and a carbon brush are fixedly connected to the discharging support frame, face the side wall of the top conductor of the lightning protection body and extend out from the discharging support frame; the guide wheel and the carbon brush extend out from the discharging support frame to prop against the side wall of the top conductor of the lightning protection body; and the length of the current collection claw extending out from the discharging support frame is smaller than the extending length of the guide wheel. The top conductor is a conductive component such as a component made of metal.

The carbon brush in the embodiment is generally made of pure carbon and coagulating agent and has a square shape or other suitable shapes, and a lead is led out of the carbon brush. The current collection claw is also called as a lightning protection arc striking plate in a shape of plate, one side of which is serrated, wherein the serrated side faces the side wall of the top conductor of the lightning protection body. The current collection claw can be made of any conductive metal such as copper or iron, preferably stainless steel. The current collection claw can also be a component of any other shape with a convex point, and the convex point faces the side wall of the top conductor of the lightning protection body. The carbon brush can be connected with a grounding wire, and the lightning is conducted to the ground through the grounding wire. Similarly, the current collection claw can also be provided with a grounding wire for conducting the lightning to the ground. The grounding wire of the carbon brush and the grounding wire of the current collection claw can be the same one.

The carbon brush of the lightning protection device is in contact with the side wall of the top conductor of the lightning protection body, and the carbon brush can play a role in lightning protection when the lightning current received by the machine body of the lightning protection body is relatively weak or static electricity is generated due to electromagnetic induction, friction and the like. When relatively strong lightning current is received, because the lightning protection capability of the instantaneous lightning protection passing current of the carbon brush is limited, the relatively strong lightning current can perform point discharge through the assisted current collection claw, most lightning is further quickly guided onto the current collection claw in short time, and good lightning protection effect is achieved. Therefore, the lightning protection device can play double protection through the carbon brush and the current collection claw.

Two ends of the guiding elastic piece are connected with the machine body fixing frame and the discharging support frame respectively, and the relative distance between the machine body fixing frame and the discharging support frame is adjusted, so that the guide wheel is propped against the side wall of the top conductor at top portion of the lightning protection body.

According to the technical scheme, the lightning protection device is generally arranged at the top of the lightning protection body, and the lightning protection device is fixedly connected with a frame at the top of the lightning protection body through the machine body fixing frame.

The current collection claw, the guide wheel and the carbon brush are connected to the discharging support frame, the guide wheel and the carbon brush extend out of the discharging support frame in certain length to prop against the side wall of the top conductor at top portion of the lightning protection body, and the length of the current collection claw extending out from the discharging support frame is smaller than the extending length of the guide wheel, so a certain clearance is kept between the current collection claw and the side wall of the top conductor at top portion of the lightning protection body; and the clearance is the clearance distance required for lightning discharge. The clearance distance in a proper range can play an effective point discharge lightning protection role, too large clearance distance cannot play an effective lightning protection role, and the clearance distance is determined according to the required lightning protection grade, generally several millimeters; the higher the lightning protection grade is, the shorter the clearance distance is. But if the clearance distance is too short, the current collection claw can easily get in contact friction with the side wall of the top conductor at top portion of the lightning protection body and even deformation, and the point of the current collection claw can be damaged, so that the point discharge lightning protection effect is affected; and the clearance distance in certain embodiments of the present invention is 1 to 5 millimeters, for example, about 2 millimeters.

The guiding elastic piece is arranged between the machine body fixing frame and the discharging support frame, and keeps certain pre-tightening force; and the relative distance between the machine body fixing frame and the discharging support frame is adjusted by elastic deformation of the guiding elastic piece, so that a tight contact between the guide wheel on the discharging support frame and the side wall of the top conductor at top portion of the lightning protection body all the time.

Under the condition of relative displacement between the lightning protection device and the lightning protection body, the relative distance between the machine body fixing frame and the discharging support frame is adjusted by elastic deformation of the guiding elastic piece, and a tight contact between the guide wheel on the discharging support frame and the side wall of the top conductor at top portion of the lightning protection body can still be ensured, so that the discharging clearance distance is kept unchanged.

The lightning protection device provided by the embodiment of the invention can ensure effective clearance distance between the discharging point and the lightning protection body, realizing automatic adjustment of the clearance distance of the discharging point in relative movement of the lightning protection body and the discharging point to achieve effective lightning protection effect, and thus can protect the discharging point from being damaged so as to achieve self protecting and effective lightning protection effects.

The guiding elastic piece is connected between the machine body fixing frame and the discharging support frame, multiple implementation modes are adopted for keeping certain relative movement and elasticity, and preferable embodiments are provided below.

### Embodiment II

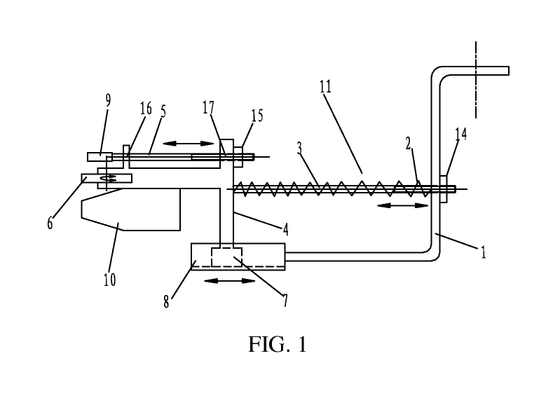

FIG. 1 is a structural schematic diagram of a lightning protection device provided by an embodiment II of the present invention. As shown in FIG. 1, the lightning protection device comprises a machine body fixing frame 1, a discharging support frame 4 and a guiding elastic piece 11.

The machine body fixing frame 1 is fixedly connected with a machine body of a lightning protection body. A current collection claw 9, a guide wheel 6 and a carbon brush 10 are fixedly connected to the discharging support frame 4, face the side wall of the top conductor at top portion of the lightning protection body and extend out from the discharging support frame 4, the guide wheel 6 and the carbon brush 10 extend out from the discharging support frame 4 to prop against the side wall of the top conductor at top portion of the lightning protection body, and the length of the current collection claw 9 extending out from the discharging support frame 4 is smaller than the extending length of the guide wheel 6.

Two ends of the guiding elastic piece 11 are connected with the machine body fixing frame 1 and the discharging support frame 4 respectively, and the relative distance between the machine body fixing frame 1 and the discharging support frame 4 is adjusted, so that the guide wheel 6 is propped against the side wall of the top conductor at top portion of the lightning protection body t.

The guiding elastic piece 11 may have different structures as long as it can serve its intended purpose, for example, it can be a spring or a rubber rod. The following scheme is adopted in the embodiment.

The guiding elastic piece 11 specifically comprises a guide rod 3 and a spring 2, the guide rod 3 is arranged between the machine body fixing frame 1 and the discharging support frame 4, the spring 2 is sleeved over the guide rod 3, and two ends of the spring 2 are connected with the machine body fixing frame 1 and the discharging support frame 4 respectively. The guide rod 3 is used for guiding the relative movement direction between the machine body fixing frame 1 and the discharging support frame 4. Further, one end of the guide rod 3 is fixedly connected with the discharging support frame 4, and the other end of the guide rod 3 passes through a unthreaded hole, such as a through hole, of the machine body fixing frame 1.

Certainly, one end of the guide rod 3 can be fixedly connected with the machine body fixing frame 1, and the other end of the guide rod 3 passes through a hole, such as a through hole, of the discharging support frame 4, not limited to the present embodiment.

By adopting above scheme, the guide rod 3 is able to move through the unthreaded hole formed in the machine body fixing frame or the discharging support frame so as to guide the displacement between the machine body fixing frame and the discharging support frame; and by arranging the spring on the guide rod, the spring generates deformation along the direction of the guide rod, and the stress deformation direction of the spring is ensured, so that the direction of relative movement between the machine body fixing frame and the discharging support frame is more accurate.

Further, one end of the guide rod 3 can also be provided with a guide thread, and the guide rod 3 is tightened and fixed on the machine body fixing frame 1 or the discharging support frame 4 through a first nut 14 and the guide thread.

The objective of adopting above scheme is that the length of the spring on the guide rod can be conveniently adjusted during installation and debugging by arranging the guide thread at one end of the guide rod, and the pre-tightening force of the spring is further adjusted, so that the guide wheel has a proper contact force with the side wall of the top conductor at top portion of the lightning protection body.

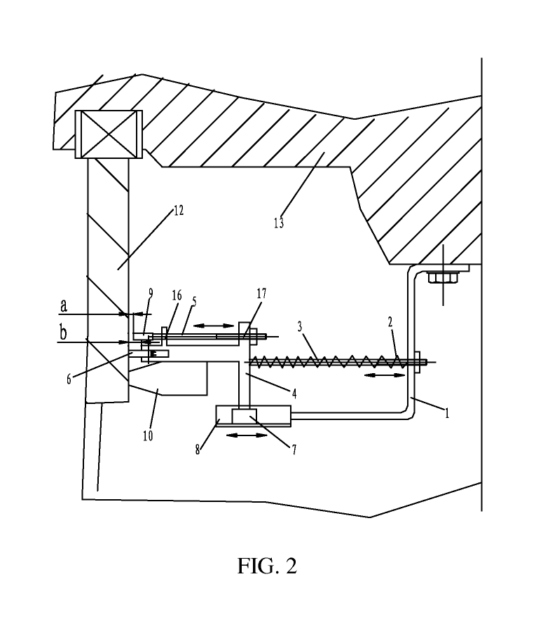

Moreover, when the guide wheel is abraded due to long-term service, the length of the guide wheel 6 extending out from the discharging support frame is adjusted by adjusting the screw-in length of the guide thread, for example, the distance b shown in FIG. 2, so that the clearance distance between the current collection claw 9 and the side wall of the top conductor at top portion of the lightning protection body is ensured, for example, the distance a shown in FIG. 2.

Based on above technical scheme, further, the machine body fixing frame 1 is glidingly connected with the discharging support frame 4. The gliding connection between the machine body fixing frame 1 and the discharging support frame 4 can be realized in different ways. In the embodiment as shown in FIG. 1, one end of the machine body fixing frame 1 is provided with a sliding groove 8, one end of the discharging support frame 4 is provided with a sliding block 7, the sliding block 7 is embedded into the sliding groove 8 and slides relatively in sliding groove 8, and the sliding block 7 can be a block or a roller or the like, not limited to the present embodiment.

The sliding groove 8 provides supporting and guiding for the sliding block 7 so as to ensure the stability of forward and back movement of the discharging support frame 4 relative to the machine body fixing frame 1; and lubricating oil can be properly added into the sliding groove to ensure the sliding lubricating property of the sliding block.

Preferably, the sliding groove 8 is oriented parallel to the axis of the guide rod 3, so that resistance when the sliding block 7 slides in the sliding groove 8 can be reduced as much as possible. The sliding groove 8 can be a U-shaped groove or a dovetail groove, and can also be designed into other shapes according to the actual requirement.

Further, the current collection claw can be fixed on the discharging support frame in various forms, preferably in the embodiment, the current collection claw 9 is connected with the discharging support frame 4 via screw and nut, and the discharging support frame 4 facing the side wall of the top conductor at top portion of the lightning protection body is sequentially provided with an unthreaded hole 16 and a threaded hole 17; and the current collection claw 9 is connected with a screw 5, the screw 5 passes through the unthreaded hole 16 and the threaded hole 17, and the screw 5 can also be tightened on the discharging support frame 4 through a second nut 15.

By adopting the above arrangement, the discharging clearance distance between the current collection claw and the side wall of the top conductor at top portion of the lightning protection body is adjusted by adjusting the screw-in length of the screw, and the distance of the discharging clearance is adjusted more conveniently during installation, debugging, maintenance and repair, so that the required lightning protection grade is met.

Optionally, the guiding elastic piece 11 in the embodiment can consists of only a spring 2, and two ends of the spring 2 are connected with the machine body fixing frame 1 and the discharging support frame 4 respectively.

However, when the guide wheel is abraded due to long-term service, the allowed maximum value of the abrasion amount of the guide wheel is the distance that the guide wheel extends out of the outer edge of the discharging support frame, namely the distance b as shown in FIG. 2; and when the maximum abrasion amount is reached or approached, the guide wheel needs to be replaced, and the screw-in length of the screw of the current collection claw should be readjusted, so that effective lightning protection clearance distance value is ensured, namely the distance a as shown in FIG. 2.

### Embodiment III

The embodiment III of the present invention provides a wind turbine, the specific structure of which is shown in FIG. 2; and the lightning protection device is arranged at the top of the iron tower of the wind turbine. The wind turbine comprises a wind rotor, a generator, an iron tower and a yawing device, and also comprises the wind turbine lightning protection device of the present invention; and the nacelle rotating part of the yawing device is used as a machine body of a lightning protection body and fixedly connected with machine body fixing frame of the lightning protection device, and the tower top flange of the iron tower is used as the top conductor at top portion of the lightning protection body and propped against the guide wheel and the carbon brush fixed on the discharging supporting frame. Because the lightning protection body of the embodiment is rotatable, a grounding wire can be connected to the tower top flange to conduct the electricity of the nacelle rotating part into the tower top flange, and then the electricity is conducted to the ground through the grounding wire on the tower top flange.

According to the preferable scheme, the tower top flange 12 is fixed with the nacelle rotating part by using a bolt, the machine body fixing frame 1 of the lightning protection device is fixed on the nacelle rotating part 13, the discharging support frame 4 is connected with the machine body fixing frame 1 through the guide rod 3, the spring 2 is sleeved on the guide rod 3, the guide wheel 6 and the carbon brush 10 are propped against the tower top flange 12, the guide wheel 6 is in contact with the inner wall of the tower top flange 12, and a certain clearance distance is kept between the current collection claw 9 and the tower top flange 12.

When the wind turbine does not execute yawing movement, the guide wheel is in relatively static contact with the inner wall of the tower top flange, a certain clearance distance is kept between the current collection claw and the tower top flange, and the value of the clearance distance is preset.

When high wind load is borne, the yawing device is started, the whole nacelle has certain excursion, the nacelle rotating part rotates synchronously, and certain deformation is generated when the wind load is transferred to the tower top flange; and when the inner wall of the tower top flange deflects to the current collection claw, the inner wall of the tower top flange is in contact with the guide wheel, so that the spring is compressed, a discharging support rod drives the current collection claw to move rightwards together, and the damage caused by contact of the inner wall of the tower top flange and the current collection claw is avoided.

When the inner wall of the tower top flange is stressed and deviates from the current collection claw, the discharging support frame drives the guide wheel and the current collection claw to approach the inner wall of the tower top flange under the push action of the elastic force of the guiding elastic piece, and the guide wheel is still in tight contact with the inner wall of the tower top flange, so the clearance distance between the current collection claw and the tower top flange can be kept unchanged.

When the wind turbine executes yawing movement, the guide wheel and the tower top flange generates relative movement, and the guide wheel can rotate around an axle; and because the guide wheel and the tower top flange are in rolling friction, the contact abrasion of the guide wheel can be reduced, and the clearance distance between the current collection claw and the tower top flange is not correspondingly adjusted due to over quick abrasion.

The closer the distance between the current collection claw and the inner wall of the tower top flange is, the better the effect of point discharge is; and if the distance is too short, the current collection claw possibly strikes through the inner wall of the tower top flange or a rotating main shaft, the current collection claw is damaged, the inner wall of the tower top flange possibly generates fine cracks and scars, the fatigue resistance of the tower top flange or the rotating main shaft is further reduced, namely as time goes on, the fine cracks and scars are gradually enlarged, and the tower top flange or the rotating main shaft is directly damaged. Therefore, the distance between the current collection claw and the inner wall of the tower top flange is set at 1 to 5 millimeters in the embodiment, so that the effect of point discharge is ensured, and the current collection claw cannot strike through the inner wall of the tower top flange. The distance between the current collection claw and the inner wall of the tower top flange can be selected according to the actual requirement. When the machining precision of the current collection claw or the tower top flange is relatively low, certain larger distance can be selected, for example, 3 millimeters; and when the machining precision of the current collection claw or the tower top flange is relatively high, certain shorter distance can be selected, for example, 2 millimeters.

Further, the distance between the current collection claw and the inner wall of the tower top flange can be set at 2 millimeters.

Moreover, the distance between the current collection claw and the inner wall of the tower top flange is smaller than the length of the guide wheel extending out from the discharging support frame to prevent the current collection claw from being in contact with the tower top flange due to the abrasion of the guide wheel.

The wind turbine provided by the embodiment can achieve effective lightning protection and ensure safe operation of the wind power generation equipment.

In addition, the lightning protection device can also be arranged on a main frame of the wind turbine. The wind turbine also comprises a main shaft, a main shaft bearing sleeved on the main shaft and the main frame connected with the main shaft bearing, and further comprises the wind turbine lightning protection device of the present invention, wherein the main shaft is a rotatable component. The main shaft is used as the machine body of the lightning protection body and fixedly connected with the machine body fixing frame of the lightning protection device, and the main frame is used as the top conductor at top portion of the lightning protection body and propped against the guide wheel and the carbon brush fixed on the discharging support frame. Therefore, lightning on the main shaft can be guided into the main frame through the lightning protection device, and then the lightning is guided to the ground through a grounding system on the main frame.

In conclusion, the embodiments are only used for explaining the technical schemes of the present invention and are not limiting; though the present invention is described in view of the embodiments, a person skilled in the art should understand that: the technical schemes recorded in the embodiments can be modified, or partial technical characteristics are equivalently replaced without departure from the spirits and scope of the technical schemes of the present invention.

What is claimed is:

1. A lightning protection device characterized by comprising a machine body fixing frame, a discharging support frame and a guiding elastic piece, wherein the machine body fixing frame is connected and fixed with a machine body of a lightning protection body; a current collection claw, a guide wheel and a carbon brush are fixedly connected to the discharging support frame, face the side wall of a top conductor at top portion of the lightning protection body and extend out of the discharging support frame, the guide wheel and the carbon brush extend out of the discharging support frame to prop against the side wall of the top conductor at top portion of the lightning protection body, and the length of the current collection claw extending out from the discharging support frame is smaller than the extending length of the guide wheel, and two ends of the guiding elastic piece are connected with the machine body fixing frame and the discharging support frame respectively, and the relative distance between the machine body fixing frame and the discharging support frame is adjusted, so that the guide wheel is propped against the side wall of the top conductor at top portion of the lightning protection body.

2. The lightning protection device according to the claim 1 characterized in that: the guiding elastic piece comprises a guide rod and a spring, wherein the spring is sleeved over the guide rod, and the guide rod is arranged between the machine body fixing frame and the discharging support frame, and two ends of the spring are connected with the machine body fixing frame and the discharging support frame respectively.

3. The lightning protection device according to the claim 2 characterized in that: one end of the guide rod is fixedly connected with the machine body fixing frame or the discharging support frame, and the other end of the guide rod passes through an unthreaded hole of the machine body fixing frame or the discharging support frame.

4. The lightning protection device according to the claim 3 characterized in that: one end of the guide rod is provided with a guide thread, and the guide rod is tightened and fixed on the machine body fixing frame or the discharging support frame through a nut and the guide thread.

5. The lightning protection device according to any one of the claims 1 to 4 characterized in that: the machine body fixing frame is glidingly connected with the discharging support frame.

6. The lightning protection device according to the claim 5 characterized in that: one end of the machine body fixing frame is provided with a sliding groove, one end of the discharging support frame is provided with a sliding block, and the sliding block is embedded into the sliding groove and slides relatively.

7. The lightning protection device according to the claim 6 characterized in that: the sliding block is a roller.

8. The lightning protection device according to the claim 1 characterized in that: the current collection claw is connected with the discharging support frame via a screw and nut.

9. The lightning protection device according to the claim 2 characterized in that: the current collection claw is connected with the discharging support frame via a screw and nut.

10. The lightning protection device according to the claim 3 characterized in that: the current collection claw is connected with the discharging support frame via a screw and nut.

11. The lightning protection device according to the claim 8 characterized in that: one end, facing the top conductor at top portion of the lightning protection body, of the discharging support frame is sequentially provided with an unthreaded hole and a threaded hole, the current collection claw is connected with a screw, and the screw passes through the unthreaded hole and the threaded hole.

12. The lightning protection device according to the claim 9 characterized in that: one end, facing the top conductor at top portion of the lightning protection body, of the discharging support frame is sequentially provided with an unthreaded hole and a threaded hole, the current collection claw is connected with a screw, and the screw passes through the unthreaded hole and the threaded hole.

13. The lightning protection device according to the claim 10 characterized in that: one end, facing the top conductor at top portion of the lightning protection body, of the discharging support frame is sequentially provided with an unthreaded hole and a threaded hole, the current collection claw is connected with a screw, and the screw passes through the unthreaded hole and the threaded hole.

14. The lightning protection device according to the claim 1 characterized in that: the guiding elastic piece is a spring, and two ends of the spring are connected with the machine body fixing frame and the discharging support frame respectively.

15. The lightning protection device according to the claim 6 characterized in that: the sliding groove is oriented parallel to the axis of the guide rod.

16. The lightning protection device according to the claim 1 characterized in that: the current collection claw is provided with a grounding wire and/or the carbon brush is provided with a grounding wire.

17. A wind turbine, comprising a wind rotor, a generator, an iron tower and a yawing device, and characterized by also comprising the lightning protection device according to any one of the claims 1 to 16, wherein the nacelle rotating part of the yawing device is used as the machine body of the lightning protection body and fixedly connected with the machine body fixing frame, and a top flange of the iron tower is used as the lightning protection top conductor and propped against the guide wheel and the carbon brush fixed on the discharging support frame.

18. The wind turbine according to the claim 17 characterized in that: the distance between the current collection claw and the inner wall of the top flange of the iron tower is 1 to 5 millimeters.

19. The wind turbine according to the claim 17 characterized in that: the distance between the current collection claw and the inner wall of the top flange of the iron tower is smaller than the length of the guide wheel extending out from the discharging support frame.

20. The wind turbine according to the claim 18 characterized in that: the distance between the current collection claw and the inner wall of the top flange of the iron tower is 2 millimeters.
